(19) United States
(12) Patent Application Publication
(10) Pub. No.: US 2003/0065774 A1
(43) Pub. Date: Apr. 3, 2003

(54) Peer-to-peer based distributed search architecture in a networked environment

(76) Inventors: Donald Steiner, Richmond, CA (US); Michael Kolb, Richmond, CA (US)

Correspondence Address: GARY CARY WARE & FREIDENRICH LLP, 1755 EMBARCADERO ROAD, PALO ALTO, CA, 94303-3340, US

(21) Appl. No.: 09/866,224

(22) Filed: May 24, 2001

(51) Int. Cl. G06F 15/16; G06F 15/173

(52) U.S. Cl. 709/225; 709/219

(57) ABSTRACT

The present invention provides a distributed resource search mechanism in a peer-to-peer computer network comprising a resource requester, search brokers, and resource providers. In a preferred embodiment of the invention, the distributed search mechanism provides methods: findResourceProviders, registerResourceProvider, GetResourceDescription, findLocalResources, and findResources. In one embodiment of the invention, a search for network resources is performed by registering resource providers with one or more search brokers on the network. When a resource requester sends a resource query to one or more search broker(s), the search broker, upon receiving the resource query, searches its local database for resource providers that may have information matching the resource query, and sends the resource query to those selected resource providers. The selected resource providers, upon receiving the search query from the search broker, search their local databases for matching resources, and send the search results directly to the resource requester.

### BACKGROUND OF THE INVENTION

This invention relates generally to search techniques in networked environments. More specifically, the invention relates to distributed resource search methods in a peer-to-peer network architecture.

Conducting a search is a pervasive and ubiquitous activity on networks such as the Internet. A web search on the Internet is more than merely locating web data. It can be a useful tool in a variety of ways. For example, a search can be used to find network resources such as bandwidth, storage and computing capacity. A search can also be used to find specific application programs that exist on the network. For example, when a user needs an e-mail service, text translation service, or file transfer service, the user can search the Internet for the necessary application programs available to the user. A search can also perform more sophisticated data search operations. For example, a search can find relevant information such as location of specific computer users, types of data in a database, and products or services offered by an E-commerce vendor.

The efficiency and cost of a web search depend on the architecture of the computer network. Computer networks can be largely classified as using a client-server architecture or a peer-to-peer architecture. In conventional client-server architectures such as used by Yahoo, Alta Vista, or Google, a single computer is dedicated as a central server to serve other computers on the network. When a user sends a search query to the search engine, the dedicated central search engine performs the necessary search on behalf of the user. For example, the central server of Yahoo receives a search query, determines the criteria for finding matching information, finds the resources, and returns the results to the user, without user interruptions.

FIG. 1 illustrates the block diagram of a conventional client-server network 100. In FIG. 1, each computer or process on the network is either a client or a server. For example, clients 103, 105, 107, and 109 are connected to a central server 101. A server cannot function as a client, and a client cannot function as a server. The server 101 is typically implemented by a powerful computer or process dedicated to managing disk drives (file servers), printers (print servers), or network traffic (network servers). Alternatively, a server itself may comprise a plurality of computers. In this case, the plurality of computers are represented to the users as one machine process. Clients 103-109 may comprise personal computers or workstations on which users can run applications. Clients 103-109 rely on the server 101 for resources such as files, devices and even processing power.

Since a client-server network relies on the central server to process the queries of all client computers, the network requires a high-performance central server and expensive high-bandwidth network connection. The extent and efficacy of a search are entirely dependent on the central server. However, a server has a limited capacity to store information. Thus, when the server does not have the information being sought by a client, the client cannot obtain the desired information from the server even if that same information may be present on some computers within the network. Further, there is additional burden for the network administrator to balance the complex load for large search engines. Also, because the network implementation is complicated, it is expensive to update the server or change the configuration of the network to reflect the recent changes in the resource availability or accommodate newly created needs.

A peer-to-peer architecture avoids some of the problems associated with client-server architectures. In a peer-to-peer architecture, the nodes have equivalent responsibilities, and each node can act as both server and client. Using a peer-to-peer architecture, a search can be conducted more thoroughly and efficiently because if any computer in the network has the information being sought, the information can be obtained from the computer without relying on a central server, which may not have the information. Thus, the cost and efficiency of a web search on a peer-to-peer network are improved because recent changes and updates can be incorporated and made available to the users in a more expeditious and less expensive way.

Further, in a peer-to-peer architecture, because the search is performed by a large number of systems on the network, not by a central server as in a client-server network, the load on the network is widely distributed and balanced, resulting in better performance and response times. Peer-to-peer architecture can coexist and integrate with a conventional client-server system because a peer-to-peer system is a subset of client-server system.

However, conventional search mechanisms based on peer-to-peer architectures are relatively expensive and inefficient. For example, in a peer-to-peer communication such as hosted by Napster™, a minimum of four (4) communication links are required to complete a search: i] a user initiates a search for music by first accessing and issuing a query to a directory server; ii] the directory returns a list of resource provider(s) to the user; iii] the user sends one or more requests to the resource provider(s); and iv] the resource provider(s) return search results to the requesting user.

Even if a search broker is provided between the user and the resource providers, conventional searches still require a minimum of four (4) communication links to complete a search: i] a user initiates a search, for example, for music by first accessing and issuing a query to a search broker; ii] the search broker sends a search query to one or more resource provider(s); iii] the resource provider(s) return search results to the search broker; and iv] the search broker returns the search results to the requesting user.

In view of the foregoing, it is highly desirable to provide a search technology that minimizes reliance on a central server, and reduces the need for high-capacity bandwidth connections and storage devices. It is also desirable to provide a search technology that minimizes the number of communication links and reduces the response time for a search on peer-to-peer architecture. It is to these ends that the present invention is directed.

### SUMMARY OF THE INVENTION

The invention provides a distributed resource search mechanism in a peer-to-peer computer network that addresses the foregoing and other problems of known search mechanisms and architecture. In one aspect of the invention, the network comprises a resource requester, search brokers, and resource providers and various associated methods including findResourceProviders, registerResourceProvider, GetResourceDescription, findLocalResources, and findResources executable on the network to enable a distributed search.

The findResources may be used by a resource requestor to find and create a list of resources on the network that match the query. The findResourceProviders may be used by a search broker to create a list of resource providers who can handle the query, given an input of specific search terms. The registerResourceProvider may be used by a search broker to register the initiating node or agent with one or more search broker(s).

The GetResourceDescription may be used by a resource provider to perform the registration of a resource provider with a search broker. The findLocalResources may be used by a resource provider to conduct a search locally, given an input of specific search terms. Additionally, the setTimeOut( ) may be used by a resource requester to set a time out period for a resource provider.

In another aspect of the invention, a search for network resources is performed by registering resource providers with one or more search brokers on the network. A resource requester sends a resource query to one or more search broker(s) to initiate a search for resources. One or more search brokers, upon receiving the resource query, search their registration databases to find resource providers that may have information matching the resource query. The search brokers select candidate resource providers and send the resource query to the candidate resource providers. The candidate resource providers, upon receiving the search query from the search brokers, search their databases to find matching resources. The resource providers then send the search results directly to the resource requester without involving search brokers.

The invention uses search brokers that have access to distributed resource providers on the network, allowing the resource requestor to tap into the resources of multiple resource providers on the network and obviating the need for a central server.

### BRIEF DESCRIPTION OF THE DRAWINGS

FIG. 1 illustrates the block diagram of a conventional client-server network;

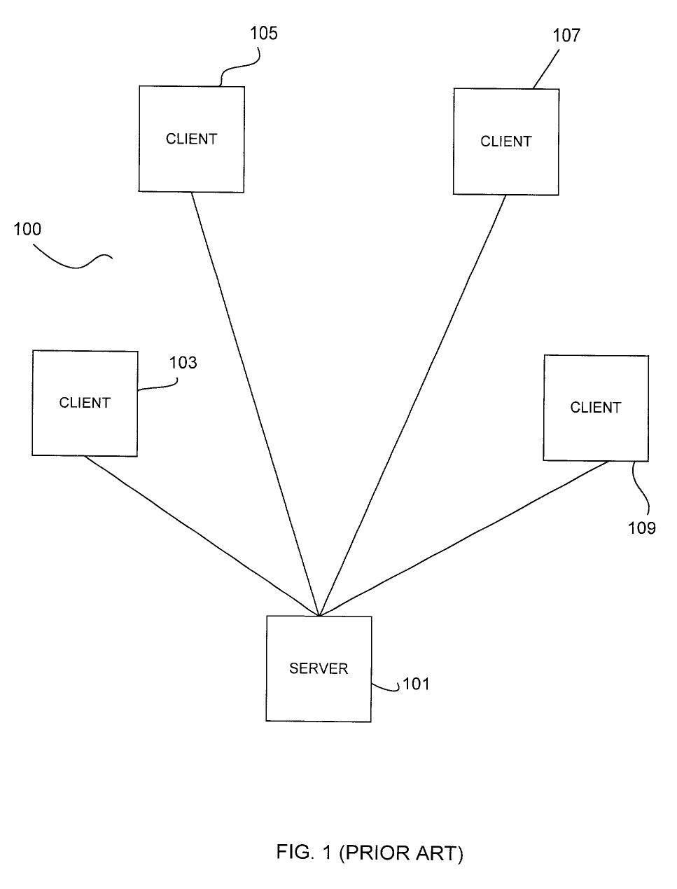

FIG. 2 illustrates a network of the type which may be used with the invention;

FIG. 3 is a flowchart illustrating a resource search process involving an initiating agent, a search broker, and a resource provider on the peer-to-peer system of FIG. 2; and

FIG. 4 illustrates the architecture of a computer system constructed in accordance with a preferred embodiment of the invention.

### DETAILED DESCRIPTION OF A PREFERRED EMBODIMENT

The invention provides distributed search mechanisms in a networked environment such as the Internet for performing web based resource searches and will be described in that context. It will be appreciated, however, that the distributed search mechanisms in accordance with the invention may have greater utility, and are applicable to other types of applications on the Internet, such as for general knowledge management and supply chain management. To understand the distributed search mechanisms in accordance with the invention, the basic architecture of the distributed search mechanisms will first be described. Then, the application of the distributed search mechanisms will be described in conjunction with peer-to-peer network architecture.

Overview—Peer To Peer Communication Architecture

A peer-to-peer network is a type of network in which the nodes such as PCs or workstations have equivalent capabilities and responsibilities. In contrast to client/server architecture in which some computers are dedicated to serving the other computers, there is no dedicated server in a peer-to-peer network. Every computer in a peer-to-peer network can share files, computing resources, and peripherals with all other computers on the network, if they are granted access privileges.

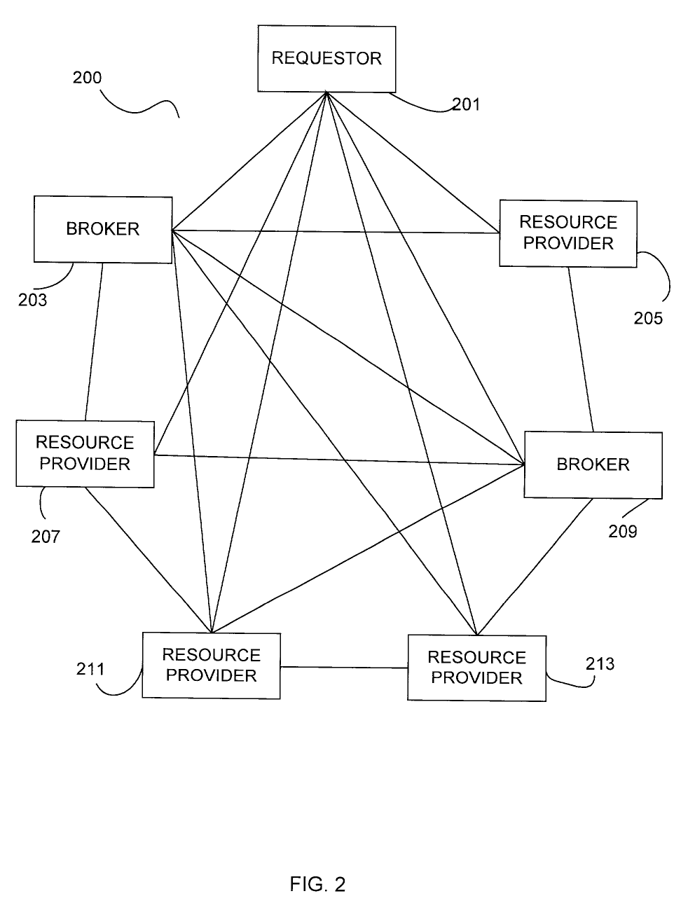

FIG. 2 illustrates a network 200 of the type that can be used in conjunction with the invention. In FIG. 2, six (6) nodes or computers are shown in the network 200 for illustrative purposes, but more or fewer nodes may be used. Each node 201-213 can be implemented by any suitable computer such as a PC (personal computer) or a workstation or even by another network.

In FIG. 2, a resource requester 201 may be coupled to brokers 203 and 209, and resource providers 205, 207, 211 and 213. The resource requester 201 is a computer that initiates a search query. The broker computers 203 and 209 are provided to register available network resources and coordinate searches on the network 200. The network 200 may be a peer-to-peer, client-server, three-tier, or any other topology. If the network 200 is a client-server network, each node can assume the role of a requester, a search broker, or a resource provider without causing conflict with existing client-server protocols.

The search brokers 203 and 209 provide a directory service matching query types to potential resource providers that can respond to this type of query. The registration process includes mechanisms for handling situations where resource providers are temporarily unavailable (e.g. a home PC that has been disconnected from the Internet) or that could connect at different points at different times (e.g. a laptop, personal digital assistant (PDA), or cellular phone).

Each node 201-213 can assume multiple roles, i.e., function as different entities. These include a requester, a resource provider or some other role such as a broker. At any given moment within a search process, however, there is only one requester in the network 200. There can be one or more brokers, and one or more resource providers on the network 200. Also, a given node's role may also change from time to time. For example, a node may generally be a resource provider, except when a user of the node issues a query, in which case the node becomes a requester, and may continue to be a resource provider if the search is to be locally performed.

A requestor is the node that initiates a resource query. Typically, a resource requestor initiates a query by sending a resource query to one or more resource brokers. The resource brokers are used to facilitate and expedite a search process. Specifically, the resource brokers maintain a database of resources available network. When a resource query is received, a resource broker attempts to find a resource matching the resource query. The resource providers are the nodes that have access to various resources. When a resource query is received, a resource provider retrieves and sends the requested resource to the requester if there is a matching resource.

In order to implement entities such as a requester, a resource provider, and a search broker, the invention provides various data types and functions associated with the entities. Table. 1 illustrates data types used for peer-to-peer based distributed search in accordance with a preferred embodiment of the invention.

TABLE 1

| Data Type | Description |
|---|---|
| Resource | The actual resource offered by a resource provider. |
| ResourceDescription | A description of the resource, including the type of the resource, the type |
| | of search broker with which it should be registered, optional update |
| | policies (if the resource is dynamic), and the actual description of the resource. |
| ResourceQuery | The form of query used to locate the resource. |

In the example shown in Table 1, there are three (3) data types: Resource, ResourceDescription, and ResourceQuery. The Resource is data representation used for the search results returned from a resource provider. The ResourceDescription indicates the registration data that a resource provider registers with one or more search brokers. The ResourceQuery is used for the search terms from a requester to a search broker(s), and for the search terms from a search broker(s) to a resource provider(s).

In addition to the specification of data types, associated methods or functions may be used in conjunction with the invention as appropriate. Table 2 illustrates selected methods or functions that can be used in accordance with the invention. It will be apparent, however, to one skilled in the art that these are merely examples, and other suitable methods may be used as well.

TABLE 2

| Role | Method | Arguments | Return Value |
|---|---|---|---|
| Resource Requestor | presentResources | List of Resource | |
| | findResources | ResourceQuery | List of Resource |
| Search Broker | findResourceProviders | ResourceQuery | List of |
| | | | ResourceProvider |
| | registerResourceProvider | ResourceProvider, | |
| | | ResourceDescription | |
| Resource Provider | getResourceDescription | none | ResourceDescription |
| | findResourceBrokers | none | List of |
| | | | ResouceBrokers |
| | findLocalResources | ResourceQuery | List of Resource |
| | setTimeOut() | Int | |

In the example shown in Table 2, a resource requestor may use methods: presentResources and findResources. The presentResources method may be used to rank the search results and to make use of them. The findResources may be used to create a list of resources on the network that match the query. A search broker uses methods: findResourceProviders, and registerResourceProvider. The findResourceProviders method may be used to create a list of resource providers who can handle the query, given an input of specific search terms. The registerResourceProvider method may be used by each search broker to register a resource provider with the search broker.

Still referring to Table 2, a resource provider may use methods: GetResourceDescription, findResourceBrokers, findLocalResources, and setTimeOut( ). The GetResourceDescription method may be used to get the description of the resources provided by the resource provider, that is used for the registration of the resource provider with a search broker. The findResourceBrokers method may be used to find search broker computers on the network. The findLocalResources method may be used to conduct a search locally on a resource provider, given an input of specific search terms. The setTimeOut( ) may be used to set a time out period by which a response is expected from a resource provider. After the time out period has expired, the resource requester analyzes all received responses to the query.

In addition to the methods illustrated in Table 2, requesters, resource providers, and search brokers may use well-known send and receive methods such as TCP/IP, MQSeries, and HTTP in order to send and receive information in the network.

Distributed Search System

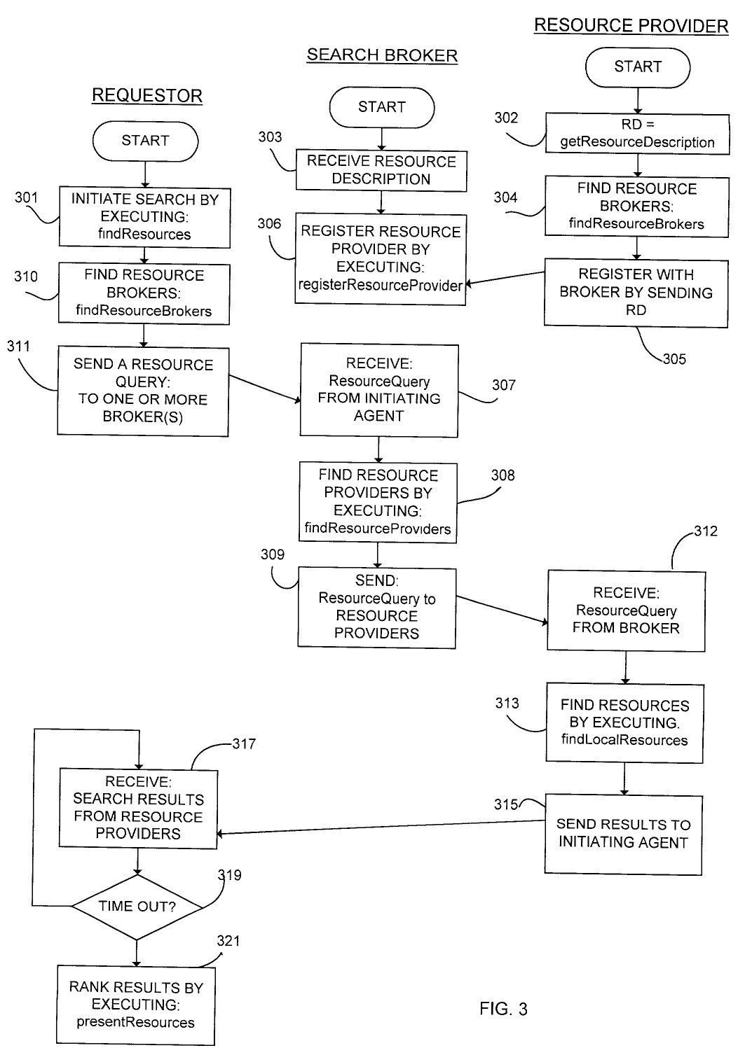

FIG. 3 is a flowchart illustrating a resource search process in one embodiment of the distributed search system of the invention. In FIG. 3, there are three (3) participants: a resource requestor (initiating agent), one or more search broker(s), and one or more resource provider(s). At any given moment, there is only one requestor in the search process. To enable a distributed web search, each participating resource provider first registers descriptions of its available resources with one or more search brokers. The registration process is used to provide the search brokers with the information needed to determine which resource providers should be sent a specific query.

In FIG. 3, a resource provider such as resource provider 205 executes the method getResourceDescription in step 302 in order to get a list of resource descriptions. The resource provider then finds search brokers available on the network in step 304 by executing the method findResourceBrokers. Once search brokers on the network are found, the resource provider registers its resources with one or more search brokers such as broker 203 in step 305 by sending resource descriptions. The search broker, upon receiving the resource descriptions, executes the method registerResourceProvider in step 306 in order to register the resource provider. The steps 303 and 306 may be executed multiple times in order to register multiple resource providers.

When applied to a web search, resource descriptions may comprise keywords that represent the contents of all the pages for a user, and the specific information registered with a search broker is those keywords. In this application, the user's pages include each page hosted by the resource provider for that user, and each page in the bookmark and/or history file of the user's browser. Since the resource provider typically has one URL for bookmarked pages and pages in the history file, the bookmarked pages and pages in the history file are refetched in order to calculate the keywords for the pages. The resource providers calculate keywords for any new pages hosted or viewed. In a preferred embodiment, the resource providers regularly update the search brokers in order to keep the search brokers up-to-date on the latest pages hosted and viewed by the resource providers. It will be appreciated by one skilled in the art that any suitable information other than keywords can be used to register resources without departing from the scope of the invention.

To initiate a resource search, an initiating requester such as the node 201 executes findResources to start the search process in step 301. The resource requester then finds search brokers available on the network in step 310 by executing the method findResourceBrokers. In step 311, the resource requester transmits a resource query to one or more search brokers such as the search brokers 203 and 209. Preferably, the resource query comprises the network address of the resource requester to allow the recipient of the query to respond directly to the resource requester.

The search broker receives the query in step 307, and finds resource providers by executing findResourceProviders in step 308. In a preferred embodiment, in step 308, the search broker determines candidate resource providers that are most suitable for responding to the query by comparing the keywords in the query to the keywords registered by the resource providers. The search broker forwards the resource query to those candidate resource providers who can respond to the query in step 309. Alternatively, when the search broker cannot find a suitable resource provider or the candidate resource providers are unavailable, the search broker may initiate a search of its own by forwarding the resource query to other search brokers in order to find candidate resource providers. In this case, the search brokers may be organized in a hierarchical relationship. The steps 307-309 may be repeated multiple times in order to receive and process multiple resource queries.

The selected resource providers receive the resource query in step 312, and executes the method findLocalResources in step 313 to search for the resources that match the keywords. In a preferred embodiment of the invention, each of the candidate resource providers on the network tries to satisfy the query by looking for information in web pages hosted by the resource providers and in web pages that have been viewed by users of the resource providers. However, in an alternate embodiment of the invention, some resource providers may decide to ignore the resource query or delay responding to it. The search in step 313 may include the web pages that the resource provider hosts, as well as the web pages that the resource provider's users have visited. In one embodiment of the invention, the search is performed using a pre-computed index generated at the time the responding resource provider calculated the keywords for the page.

The resource providers deliver the search results directly to the original requester in step 315. Optionally, the resource providers may also deliver the search results to the search broker in order to allow caching of the information. By using cached information, the search broker can respond to the same query more quickly without having to communicate the query to resource providers. The steps 312, 313 and 315 may be repeated multiple times in order to receive and process multiple resource queries.

The original resource requester receives the output (search results) of the responding resource provider in step 317, and determines whether a time period to await the search results has expired in step 319. The original requester may use a variable CollectedResults to collect the search results returned from the resource providers. If the time period has expired in step 319, then the requester stops accepting any new search results, and may optionally execute presentResources in step 321 to rank and present the received search results. If the time period has not expired in step 319, the requester continues to step 317, and waits to receive additional search results from other resource providers.

Thus, as will be appreciated by the foregoing, the resource search of the invention obviates the reliance on a central server. In contrast to conventional client-server architecture which relies on a single central server, the invention does not require a central server. Instead, the invention uses search brokers that have access to distributed resource providers on the network, allowing a resource requester to tap into the resources of multiple resource providers.

Also, in contrast to prior art peer-to-peer search mechanisms, the invention requires a minimum number, three (3) in this case, of connection links to complete a resource search in a distributed network: i] from a resource requestor to a search broker; ii] from the search broker to a resource provider; and iii] from the resource provider to the resource requestor. This results in an efficient and expeditious resource search in a distributed network.

As discussed above, each network node can assume one or more of the following roles: resource requester, search broker, and resource provider. For this purpose, a computer on the network may be controlled by resource requester software, broker software, and resource provider software in order to provide resource requester, search broker, or resource provider functions. Also, in order to assume multiple roles, the computer may include multiple software units. For example, a computer having resource requester software, broker software, and resource provider software has capability to function as a resource requester, search broker, and resource provider. Whether a computer on a node in the network activates any particular software depends on the particular role of the computer in a given transaction.

Resource Requestor Software

The invention provides resource requester software for a resource requestor. The resource requestor software program may perform the following operations: automatic recording of the information on the Web as viewed by a user; storing, accessing and managing the information on the user's local machine; and communication with other agents on the Internet. In the embodiment shown in FIG. 3, the resource requestor software performs the methods: findResources, send, and receive shown in steps 301, 311, and 317 respectively. However, other functions or methods may be included in the resource requestor software as desired.

Using the data types and methods described in Tables 1 and 2, a user or a resource requestor may initiate a search for resources on the network 200 by invoking the method findresources:

/* Exemplary psuedocode for a requester initiating a resource search */

Resource[ ] List_of_Resource

List_of_Resource findResources(ResourceQuery)

The findResources launches subsequent methods to complete the search process. For example, the findresources launches the findResourceBrokers method as the next step.

Preferably, the method findResourceBrokers accesses an external database using UDDI (universal description discovery integration) specifications (well-known in the art, thus not described in detail) to obtain a list of search brokers on the network. An exemplary pseudocode for the method findResourceBrokers can be written as follows:

/* Exemplary pseudocode for the method findResourceBrokers using UDDI */

SearchBroker[ ] List_of_brokers;

List_of brokers=find_business(service, search_broker);

However, a resource provider may also access any suitable database of search brokers available on the network or off the network. Any suitable mechanism other than UDDI may be used to access a search broker database. For example, LDAP (lightweight directory access protocol) can be used to find a search broker database separately or in combination with UDDI. UDDI and LDAP permit a resource provider to find search brokers dynamically after the network is created and configured. Alternatively, a search broker database may be established prior to a search for search brokers. In this alternate embodiment, a search broker database is established and the information regarding its existence and network address may be made available to the computers on the network. The findResourceBrokers then can access the search broker database without relying on a dynamic search service such as UDDI or LDAP.

An exemplary pseudocode for the send method can be written as follows:

/* Exemplary pseudocode for the method send */

send(ResourceQuery, List_of_brokers);

In a preferred embodiment, a resource query comprises set of words or keywords. However, it will be appreciated by one skilled in the art that other methods such as those based on contexts, fuzzy logic, affinity, and objective function may be used as the resource query instead of keywords without departing from the scope of the invention.

An exemplary pseudocode for the receive method can be written as follows:

/* Exemplary pseudocode for the method receive */

Search_results=receives( );

The actual communication algorithm for sending and receiving can be implemented by using any suitable communication mechanism such as TCP/IP (transmission control protocol/internet protocol), SMTP (simple mail transfer protocol), HTTP (hypertext transfer protocol) and UDP (user datagram protocol) without departing from the scope of the invention.

An exemplary pseudocode for the method presentResources can be written as follows:

/* Exemplary pseudocode for the method present resources */

sort the search results;

remove duplicate results;

send to graphical user interface for display to the user;

Any suitable sorting algorithm may be used in conjunction with the invention. For example, a quicksort algorithm may be used as the sort algorithm. The method presentResources also removes duplicate search results before presenting the results to the user. In a preferred embodiment, the search results are displayed to the user by GUI (graphical user interface), although other methods of presenting the search results to the user may be used. For example, non-GUI methods may be used to present the search results.

Search Broker Software

The present invention also provides search broker software to facilitate and expedite a search process. Specifically, in order to enable a distributed search, a resource requester needs to find the resources stored on other computers in the network that match a given query. A search broker (SB) enables a initiating resource requester to find resources relevant for a query.

In the example illustrated in FIG. 3, a search broker may use the methods: findResourceProviders, registerResourceProvider, send, and receive shown in steps 308, 306, 309, and 303 and 307 respectively. It will be apparent, however, that any other functions or methods may be used with the search broker software as desired.

An exemplary pseudocode for the method registerResourceProvider can be written as follows:

/* Exemplary pseudocode for the method registerResourceProvider */
struct Entry_ResourceProvider {

| | |
|---|---|
| ResourceProvider | Provider_ID; |
| ResourceDescription | Provider_Resource |

| } | |
|---|---|
| Entry_ResourceProvider[ ]; | Table_ResourceProviders |
| If TableExist == True | |

then add the resource provider to Table_ResourceProviders;
else create a Table_Resource_Providers and add the resource
provider to

Table_ResourceProviders;

Table 3 is an example of the table of registered resource providers established by a search broker after performing the method registerResourceProvider for ResourceProviders 1, 2 and 3. In a preferred embodiment of the invention, resource descriptions comprises keywords such as “electronic parts.” Other methods can be used to describe resources such as context-based, fuzzy logic-based, affinity-based, and objective functions.

TABLE 3

| Mapping Index | ResourceDescription | ResourceProviders |
|---|---|---|
| 1 | Electronic parts | ResourceProvider 002 |
| 2 | Automotive parts | ResourceProvider 002 |
| 3 | Travel | ResourceProvider 003 |
| | | ResourceProvider 004 |
| 4 | Home loan | ResourceProvider 001 |
| 5 | Auto loan | ResourceProvider 001 |

As shown in Table 3, the registration of a ResourceProvider may insert resource providers into a table using a mapping function. The invention may use a hash function as the mapping function. A hash algorithm turns messages or text into a fixed string of digits or index, usually for security or data management purposes. Thus, using an identical hash algorithm, the same value will be assigned to the same word in an agent's hash table and in the search broker's hash table. Any suitable hash function may be used based on performance requirements. It is possible that two different words can get mapped onto the same hash value. A hash algorithm is one way because it is nearly impossible to derive the original text from the string.

When a hash function is used as table look-up index as in Table 3, it creates a mapping index to facilitate the insertion and search of a resource of interest. For example, in Table 3, the hash function may produce a mapping index of four (4) for the keyword “home loan.” If there are more than one resource providers that provide a resource, then the ResourceProviders field of Table 3 may contain multiple entries. For example, since ResourceProviders 3 and 4 provide travel related services, the ResourceProviders field of index 3 contains both resource providers.

An exemplary pseudocode for the method findResourceProviders can be written as follows:

/* Exemplary pseudocode for the method findResourceProviders */

index=hash_function (ResourceQuery)

List_of_ResourceProviders=Table_ResourceProviders (index);

Return List_of _ResourceProviders;

For example, in order to find resource providers that provide electronic parts retail service, the findResourceProviders method may transform the query terms “electronic parts” into an index using a hash function. Since the hash function in this example returns an index of 1 in Table 3, the resource provider 2 is chosen as a candidate resource provider.

When there is no exact match for the resource query in the resource provider database, for example, when the resource query is “microprocessor” instead of “electronic parts,” the above search algorithm will fail to find a candidate resource provider. Thus, in an alternate embodiment of the invention, a translation service may be used to interpret the resource query. In this example, the search broker processing the resource query sends the query to a computer providing a translation service. The translation computer then interprets the resource query and adjusts the resource query from “microprocessor” to “electronic parts.” The translation computer may be on the network or off the network as long as the search broker has an access to the translation computer. Also, a search broker may have the combined function of a search broker and a translation service.

Any suitable database may be used for registration purposes. For example, a binary decision tree may be used to implement registration of resource providers instead of a hash table. In this case, the search for candidate resource provider can be more flexible. For example, the matching documents may range from the best matching to the worst, and the test of whether a particular item fits the search criteria is decided by performing a comparison between the search query and the item being considered. The types of comparisons that can be used in searches vary depending on the search algorithm and search criteria. For example, a search can be performed based on exact matches, greater than or less than searches, keyword matches, contextual matches, fuzzy matches, affinity matches, and objective function matches. Also, a hash table or a binary decision tree may be implemented in software, or in hardware such as content addressable memory (CAM) to expedite the search process.

Resource Provider Software

In the example illustrated in FIG. 3, a resource provider may perform the methods: getResourceDescription, findResourceBrokers, findLocalResources, send and receive shown in steps 302, 304, 313, 315, and 312 respectively. The method getResourceDescription may be implemented on a resource provider computer by manually configuring the resource database in the resource provider. Table 4 illustrates an example of the resource database configured by a resource provider. In Table 4, there are two (2) categories and a plurality of items in each category.

TABLE 4

| Resource category | Items |
|---|---|
| Auto parts | Spark plugs |
| | Airbags |
| | Tires |
| Electronic parts | Microprocessors |
| | DRAMs (dynamic random access memory) |
| | Graphics accelerators |

The method getResourceDescription obtains a resource description by accessing the resource database. An exemplary pseudocode for the method getResourceDescription can be written as follows:

/* Exemplary pseudocode for the method getResourceDescription */

ResourceDescription RD

RD=(List of resource categories in the resource database);

When applied to the example of Table 2, RD will return the two (2) categories: auto parts and electronic parts.

The resource database may be configured automatically by the resource provider without involving a manual configuration operation.

An exemplary pseudocode for the method findLocalResources can be written as follows:

/* Exemplary pseudocode for the method findLocalResources */

Resource LR

LR=(List of resource items in the resource database);

When applied to the example of Table 4, LR will return the specific items under a category. For example, if the resource query is for auto parts, then LR returns spark plugs, airbags, and tires. If the resource query is for electronic parts, then LR returns microprocessors, DRAMs, and graphics accelerators. Typically the method findLocalResources returns the resources on the local machine or the computer that is performing the method findLocalResources. Resources can also be found by the local computer launching a separate query of its own to find additional resources. Thus, the computer that is performing the method findLocalResources may launch another resource query to find resources on other computers.

PeerBeans™ API

Some of the methods and associated data types used in the distributed search system in FIG. 3 may be implemented by application programming interface (API) software called PeerBeans™. For example, the findResources, findResourceBroker, send and receive methods are preferably implemented by the PeerBeans™ API while other methods may be implemented by an application program or in the API. For example, the methods findResources and findResourceBroker may be implemented directly by an application program.

As well known in the art, an API provides a library of software routines that can be called by an application program to make the operating system do the lower level work. An API provides platform-independent portability for application programs so that the same application program can be used on computers that have different underlying hardware and platform. An API shields the programmers from the details and specifics of the underlying hardware and platform by providing the building blocks that implement lower level functions and routines. Thus, a programmer can prepare an application program by putting together the building blocks of the API without knowledge about the details and specifics of the underlying platform. The API of the invention is dependent on the particular application, and thus application-specific, requiring a new API for a new application. Although APIs are designed for programmers, they are ultimately good for users as well because all programs using a common API will have similar interfaces. This makes it easier for users to learn and adapt to new programs.

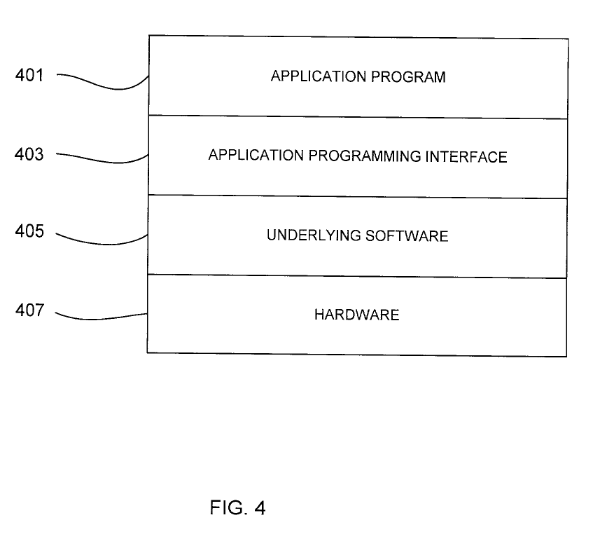

FIG. 4 illustrates the relationship of an application program, an API and underlying software architecture of a computer in one embodiment of the invention. Preferably, each computer 201-213 in the network 200 embodies the system architecture illustrated in FIG. 4, although some computers 201-213 may not include an API.

As shown, the computer system of FIG. 4 comprises an application program 401, an API 403, underlying software 405 and hardware 407. As discussed above, the API 403 preferably comprises the PeerBeans™ API. As can be in FIG. 4, the API 403 is disposed between the application program 401 and the underlying platform, which comprises the underlying software 405 and the hardware 407. The underlying software 405, in turn, may comprise an operating system, network communications, device drivers, an I/O system, and other lower level software implementation not shown.

Preferably, the PeerBeans™ API is written in the Java™ language, although other languages than Java™ may be used to implement the PeerBeans™ API. For example, C++ or C may be used to implement the PeerBeans™ API.

In order to use a method implemented by the API 403, the application program 401 makes a software call to a routine in the PeerBean™ API 403, which is then executed. For example, the application program 401 may make a software call to a send routine in the PeerBeans™ API 403/ The send routine in the PeerBeans™ API 403 may then be executed by the underlying software 405 and the hardware 407.

Distributed Search for Web Pages (URLs)

The PeerBeans™ API of the invention may be applied to implement distributed search for web pages based on their URLs (uniform resource locators). In this case, the output (search results) of the resource provider's search may comprise a list of URLs that satisfy a resource query or keywords. Table 5 illustrates data types of the PeerBeans™ API of the invention that return URL as a search result. It will be apparent that other data types and methods such as presentResources, findResourceProviders, getResourceDescription and findLocalResources may be defined and used as necessary to implement a distributed search for web pages (URL).

When the requester receives URLs from each responding resource provider, the requester may rank them using well-known methods. It is possible that a particular URL may show up in the results multiple times, since each resource provider is reporting on the URLs of web pages it has visited or bookmarked, and popular pages will be visited by more than one resource provider. Thus, the ranking method, presentResources, may be implemented based on the number of times a particular URL is returned (a popularity ranking). Alternatively, the requester may retrieve the web pages for the returned URLs in order to retrieve the actual content of interest.

TABLE 5

| Data Type | Description |
|---|---|
| Resource | A URL of a web page. |
| ResourceDescription | A keyword index of all the web pages hosted and |
| | viewed by a particular user in a resource provider. |
| ResourceQuery | A list of keywords. |

In view of the foregoing, the benefits of the invention are manifest. In particular, the peer-to-peer distributed web search of the invention has the following advantages:

the search is performed by a large number of computers on the network, not by a central server as in the case of Yahoo. This eliminates the need for a high-performance central server and the complex load balancing needed for large search engines. The load on network bandwidth is widely distributed in the peer-to-peer distributed web search architecture, in contrast to conventional search mechanisms that rely on centralized search engines that require an expensive high-bandwidth network connection;

the search results can be obtained based on both web pages served by each computer, and web pages that have been viewed through a browser running on each computer. This provides a wider, more up-to-date coverage of the content on the net;

a page frequently accessed by a large number of users will be returned to the resource requester by a large number of computers on the network. This allows the requester to rank the popularity of pages based on actual user viewing frequency;

unlike conventional centralized search techniques such as Yahoo and Google, the peer-to-peer distributed web search of the invention eliminates the need for a massive investment in disk storage.

The foregoing descriptions of preferred embodiments of the invention are presented for purposes of illustration description. However, it will be appreciated by those skilled in the art that variations of these embodiments may be made without departing from the spirit and scope of the invention, the scope of which is defined by the appended claims.

1. A distributed search method in a peer-to-peer computer network comprising a resource requester, at least one search broker, and at least one resource provider where said at least one search broker has a registration database for said at least one resource provider, said method comprising:
sending a resource query from said resource requester; to a resource broker;
locating a resource provider on the network matching said resource query;
sending said resource query from said resource broker to said resource provider matching said resource query;
processing said resource query at said resource provider matching said resource query; and
returning search results from said resource provider matching said resource query to said resource requestor.

2. The method of claim 2 further comprising locating one or more search brokers in said computer network.

3. The method of claim 2 further comprising forwarding a resource description from said resource provider to said resource broker.

4. The method of claim 3 further comprising ranking said search results at said resource requester.

5. The method of claim 4 wherein said resource description comprises types of resources.

6. A computer program product for use in conjunction with a distributed network comprising a resource requestor, at least one search broker and at least one resource provider, the computer program product comprising a computer readable storage medium and a computer program mechanism embedded therein, the computer program mechanism comprising:
first instructions for sending a resource query executable by said resource requester;
second instructions executable by said search broker for registering said resource provider;
third instructions executable by said search broker for finding said resource provider matching said resource query;
fourth instructions executable by said search broker for sending said resource query to said resource provider; and
fifth instructions executable by said resource provider for finding resources available matching said resource query.

7. The computer program product of claim 6 further comprising
sixth instructions executable by said resource provider for sending search results to said resource requester.

8. The computer program product of claim 7 further comprising
seventh instructions executable by said resource provider for finding search brokers in said computer network.

9. The computer program product of claim 8 further comprising
eighth instructions executable by said resource provider for obtaining a resource description.

10. The computer program product of claim 6 further comprising
ninth instructions executable by said resource provider for sending a resource query to a computer coupled to said resource provider.

11. A resource search method for a computer network having a plurality of computers comprising a resource requester, at least one search broker, and at least one resource provider, said method comprising:
registering said resource provider with said search broker;
sending a resource query from said resource requester to said search broker;
sending said resource query from said search broker to said resource provider;
searching said resource provider for local resources based on said resource query; and
sending search results from said resource provider to said resource requester.

12. The search method of claim 11 further comprising
sending said resource query from said resource provider to a computer coupled to said resource provider.

13. The search method of claim 11 further comprising
generating at said search broker a registration database for said resource provider.

14. The search method of claim 13 further comprising
determining whether said resource provider contains a resource that matches said resource query.

15. The search method of claim 14, wherein said resource query comprises a keyword.

16. The search method of claim 15 further comprising selecting said resource provider based on said keyword of said resource query.

17. A computer program product for use in conjunction with a distributed network comprising a resource requester, at least one search broker and at least one resource provider, the computer program product comprising a computer readable storage medium and a computer program mechanism embedded therein, the computer program mechanism comprising:
first instructions for registering said resource provider with said search broker;
second instructions for sending a resource query from said resource requester to said search broker;
third instructions for sending said resource query from said search broker to said resource provider;
fourth instructions for searching said resource provider for local resources based on said resource query; and
fifth instructions for sending search results from said resource provider to said resource requestor.

18. The computer program product of claim 17 further comprising sixth instructions for sending said resource query from said resource provider to a computer coupled to said resource provider.

19. The computer program product of claim 17 further comprising
sixth instructions for generating at said search broker a registration database for said resource provider.

20. The computer program product of claim 19 further comprising
seventh instructions for determining whether said resource provider contains a resource matching said resource query.

21. The computer program product of claim 20 wherein said resource query comprises a keyword.

22. The computer program product of claim 21 further comprising eighth instructions for selecting said resource provider based on said keyword of said resource query.

23. The computer program product of claim 22 further comprising ninth instructions for ranking said search results at said resource requester.

24. A computer network having a plurality of computers comprising a resource requestor, at least one search broker, and at least one resource provider, each computer on said computer network comprising an application programming interface (API), said API comprising;
a resource-finding method executable by said resource requester, said resource-finding method comprising a resource query;
a resource-provider-finding method executable by said search broker for finding said resource provider matching said resource query,
a resource-provider-registering method executable by said search broker for registering said resource provider; and
a local-resource-finding method executable by said resource provider for finding resources available on said resource provider.

25. The computer network of claim 24 wherein said API further comprising:
a search broker finding method executable by said resource provider for finding said search broker.

26. A resource search method for a computer network having computers comprising a resource requestor, a plurality of search brokers, and a plurality of resource providers, said method comprising:
registering said plurality of resource providers with said plurality of search brokers;
sending a resource query from said resource requestor to at least a subset of said plurality of search brokers;
sending said resource query from said subset of said plurality of search brokers to at least a subset of said plurality of resource providers;
searching for local resources based on said resource query; and
sending search results from said subset of said plurality of resource providers to said resource requestor.

27. The search method of claim 26 further comprising
sending said resource query from a resource provider to a computer coupled to said resource provider.

28. The search method of claim 26 further comprising
generating at said plurality of search brokers registration databases for said plurality of resource providers.

29. The search method of claim 28 further comprising
determining whether said subset of said plurality of resource providers contains a resource that matches said resource query.

30. The search method of claim 29, wherein said resource query comprises a keyword.

31. The search method of claim 30 further comprising selecting a resource provider based on said keyword of said resource query.

32. A computer program product for use in conjunction with a distributed network comprising a resource requester, a plurality of search brokers and a plurality of resource providers, the computer program product comprising a computer readable storage medium and a computer program mechanism embedded therein, the computer program mechanism comprising:
first instructions for registering said plurality of resource providers with said plurality of search brokers;
second instructions for sending a resource query from said resource requester to at least a subset of said plurality of search brokers;
third instructions for sending said resource query from said subset of said plurality of search brokers to at least a subset of said plurality of resource providers;
fourth instructions for searching for local resources based on said resource query; and
fifth instructions for sending search results from said subset of said plurality of resource providers to said resource requester.

33. The computer program product of claim 32 further comprising sixth instructions for sending said resource query from a resource provider to a computer coupled to said resource provider.

34. The computer program product of claim 32 further comprising
sixth instructions for generating at said plurality of search brokers registration databases for said plurality of resource providers.

35. The computer program product of claim 34 further comprising
seventh instructions for determining whether said subset of said plurality of resource providers contains a resource that matches said resource query.

36. The computer program product of claim 35 wherein said resource query comprises a keyword.

37. The computer program product of claim 36 further comprising eighth instructions for selecting a resource provider based on said keyword of said resource query.
